(19) United States
(12) Patent Application Publication
(10) Pub. No.: US 2024/0106005 A1
(43) Pub. Date: Mar. 28, 2024

(54) BATTERY

(71) Applicant: Panasonic Intellectual Property Management Co., Ltd., Osaka (JP)

(72) Inventor: EIICHI KOGA, Hokkaido (JP)

(21) Appl. No.: 18/534,633

(22) Filed: Dec. 10, 2023

Related U.S. Application Data
(63) Continuation of application No. PCT/JP2022/010449, filed on Mar. 10, 2022.

(30) Foreign Application Priority Data
Jun. 25, 2021 (JP) 2021-106149

(51) Int. Cl. H01M 10/0585; H01M 50/474

(52) U.S. Cl. CPC H01M 10/0585; H01M 50/474

(57) ABSTRACT

A battery of the disclosure includes a first cell and a second cell disposed on the first cell. The first cell includes a first positive electrode layer, a first negative electrode layer, and a first solid electrolyte layer disposed between the first positive electrode layer and the first negative electrode layer. The first cell has an outer peripheral shape that includes a first side having a curved portion in plan view. The outer peripheral shape of the first cell includes a portion on the first side that does not coincide with an outer peripheral shape of the second cell in plan view.

### BACKGROUND

### 1. Technical Field

The present disclosure relates to a battery.

### 2. Description of the Related Art

Japanese Unexamined Patent Application Publication (Translation of PCT Application) No. 2015-519691 (hereinafter referred to as Patent Literature 1) discloses a battery cell in which an electrode assembly having a structure including a positive electrode, a negative electrode, and a separation film interposed between the positive electrode and the negative electrode is built in a battery case. This battery cell has, on at least one side, an outer peripheral surface having a curved surface shape in plan view. The battery cell disclosed in Patent Literature 1 is, due to the above-described structure, able to be attached to devices having various external shapes while maintaining a capacity thereof.

### SUMMARY

One non-limiting and exemplary embodiment provides a battery with improved reliability.

In one general aspect, the techniques disclosed here feature a battery including a first cell and a second cell disposed on the first cell, in which the first cell includes a first positive electrode layer, a first negative electrode layer, and a first solid electrolyte layer disposed between the first positive electrode layer and the first negative electrode layer, the first cell has an outer peripheral shape that includes a first side having a curved portion in plan view, and the outer peripheral shape of the first cell includes a portion on the first side that does not coincide with an outer peripheral shape of the second cell in plan view.

The present disclosure provides a battery with improved reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a sectional view and a plan view depicting a schematic configuration of a battery according to a first embodiment;

FIG. 2 illustrates a sectional view and a plan view depicting a schematic configuration of a battery according to a second embodiment;

FIG. 3 illustrates a sectional view and a plan view depicting a schematic configuration of a battery according to a third embodiment;

FIG. 4 illustrates a sectional view and a plan view depicting a schematic configuration of a battery according to a fourth embodiment;

FIG. 5 illustrates a sectional view and a plan view depicting a schematic configuration of a battery according to a fifth embodiment; and

FIG. 6 illustrates a sectional view and a plan view depicting a schematic configuration of a battery according to a sixth embodiment.

### DETAILED DESCRIPTIONS

Embodiments of the present disclosure will be specifically described below with reference to the drawings.

Note that each embodiment described below represents a comprehensive or specific example. Numerical values, shapes, materials, constituents, layout positions of the constituents, modes of connection of the constituents, a manufacturing process, the order of the manufacturing steps, and the like discussed in the following embodiments are mere examples and are not intended to restrict the scope of the present disclosure.

In the present specification, terms that represent relations between elements as typified by being perpendicular, terms that represent shapes of the elements as typified by a rectangular parallelepiped, and numerical ranges are not expressions that represent only precise meanings but are rather expressions that encompass substantially equivalent ranges with allowances of several percent, for example.

The respective drawings are schematic diagrams and are not always illustrated precisely. Accordingly, scales and other factors do not always coincide with one another in the respective drawings, for example. Moreover, in the respective drawings, structures that are substantially the same are denoted by the same reference signs and overlapping explanations thereof will be omitted or simplified.

In the present specification and the drawings, x-axis, y-axis, and z-axis represent three axes of a three-dimensional orthogonal coordinate system. In each embodiment, z-axis direction is defined as a thickness direction of a battery. In the present specification, the “thickness direction” means a direction perpendicular to laminated surfaces of respective layers in a battery and a cell unless otherwise stated.

In the present specification, “in plan view” means a case of viewing a battery in a direction of lamination of cells unless otherwise stated. In the present specification, the “thickness” is a length in the direction of lamination in a battery element and of respective layers therein unless otherwise stated.

In the present specification, a “side surface” of a cell means a surface extending in the direction of lamination of the cells while a “principal surface” means a surface other than the side surface unless otherwise stated.

Regarding terms “in” and “out” as seen in “inward”, “outward”, and the like in the present specification, “in” represents a direction toward a center of a battery and “out” represents a direction toward a periphery of the battery when the battery is viewed in the direction of lamination of the cells.

In the present specification, terms “up” and “down” concerning the configuration of the battery do not represent an upward direction (vertically upward) and a downward direction (vertically downward) in light of absolute spatial recognition, but are used as terms to be defined depending on a relative positional relationship based on the order of lamination in a laminated structure. Moreover, the terms “on” and “below” are used not only in a case where two constituents are disposed close to each other and these two constituents are in contact with each other, but also in a case where two constituents are disposed with an interval therebetween and another constituent is present between these two constituents.

### First Embodiment

A battery according to a first embodiment will be described.

The battery according to the first embodiment includes a first cell and a second cell disposed on the first cell. The first cell includes a first positive electrode layer, a first negative electrode layer, and a first solid electrolyte layer disposed between the first positive electrode layer and the first negative electrode layer. The first cell has an outer peripheral shape that includes a first side having a curved portion in plan view. The outer peripheral shape of the first cell includes a portion on the first side that does not coincide with an outer peripheral shape of the second cell in plan view. In other words, the first cell and the second cell that are laminated have different shapes from each other at least between the first side of the first cell and a side of the second cell corresponding to the first side of the first cell. That is to say, the battery according to the first embodiment includes the first cell and the second cell having different shapes from each other in plan view. It is to be noted, in the present specification, that the aspect of the first cell and the second cell having different shapes from each other in plan view means that the outer peripheral shapes of the first cell and the second cell are different from each other in plan view in the laminated state. Accordingly, even when the first cell and the second cell each have an identical shape, for example, the cells are considered to have the different shapes from each other if at least parts of the outer peripheral shapes do not coincide with each other in plan view in the laminated state, depending on the orientation in the course of lamination.

Since the battery according to the first embodiment includes the first cell and the second cell that have different shapes from each other in plan view as described above, steps (irregularities) are formed on a side surface of the battery. This increases a deformation property of an outer peripheral portion of the battery. The deformation property of the outer peripheral portion can appropriately absorb or disperse an external stress such as deflection even when the stress is applied to a thin-layer and large-sized battery. As a consequence, it is possible to suppress the occurrence of delamination and cracks from the side surface of the battery to the inside of the battery. Moreover, the first cell includes the first side having the curved portion in terms of the outer peripheral shape in plan view. The first cell having the above-mentioned first side facilitates absorption or dispersion of the stress applied to a laminated body formed from the first cell and the second cell. As a consequence, the stress applied to the laminated body of the first cell and the second cell is relaxed. Hence, the battery according to the first embodiment suppresses interlayer delamination and cracks even in the case of forming the thin-layered and large-sized battery, and can therefore achieve high reliability.

As described in the section “Description of the Related Art”, Patent Literature 1 discloses the battery cell in which the electrode assembly having the structure including the positive electrode, the negative electrode, and the separation film interposed between the positive electrode and the negative electrode is built in the battery case, and the outer peripheral surface thereof has the curved surface shape in plan view. However, this battery cell is a battery that contains an electrolytic solution. Accordingly, unlike the battery such as the battery of the first embodiment that includes the first cell being a solid-state cell including the solid electrolyte layer, the battery cell of Patent Literature 1 is less likely to develop delamination and cracks from the side surface to the inside of the battery due to the external stress such as deflection.

In the battery according to the first embodiment, the second cell may include a second positive electrode layer, a second negative electrode layer, and a second solid electrolyte layer disposed between the second positive electrode layer and the second negative electrode layer. As mentioned above, the first cell is the solid-state cell of which the electrolyte layer is the solid electrolyte layer. In other words, the battery according to the first embodiment may be an all-solid-state state cell in which both the first cell and the second cell are the solid-state cells.

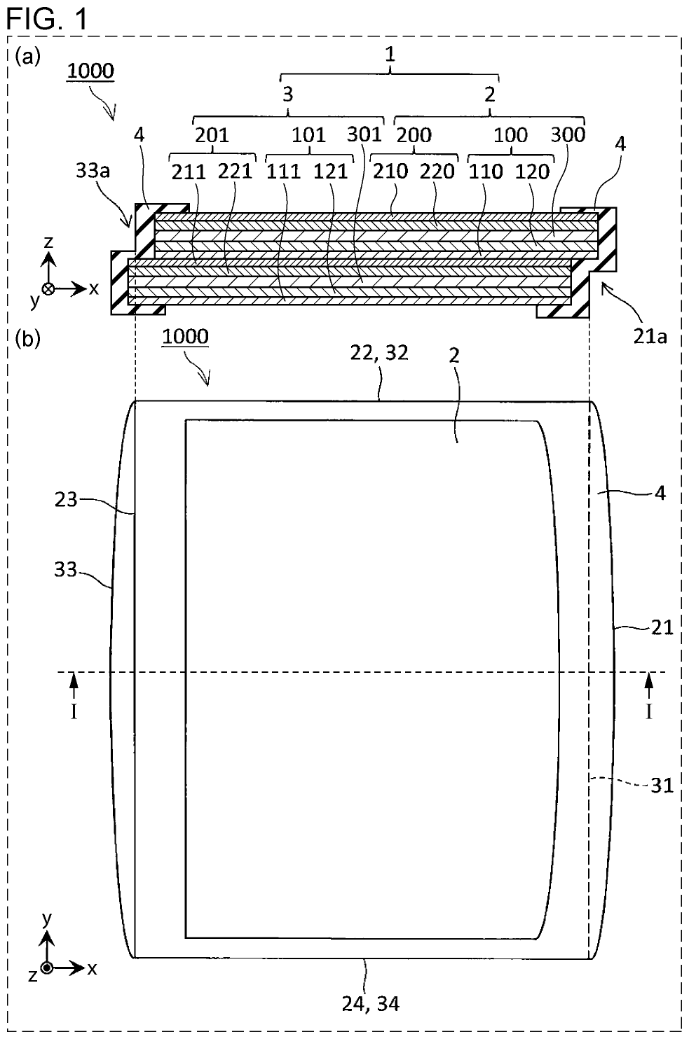

FIG. 1 illustrates a sectional view and a plan view depicting a schematic configuration of a battery 1000 according to the first embodiment. FIG. 1(a) illustrates the sectional view of the battery 1000 according to the first embodiment. FIG. 1(b) illustrates the plan view of the battery 1000 viewed from a positive side in the z-axis direction. FIG. 1(a) illustrates the section taken at a location indicated by line I-I in FIG. 1(b).

The battery 1000 includes a first cell 2 and a second cell 3. The first cell 2 and the second cell 3 are laminated on each other. In the battery 1000, a laminated body of the first cell 2 and the second cell 3 constitutes a battery element 1.

The battery 1000 may further include an insulating member 4 that covers at least part of a side surface of the first cell 2. The insulating member 4 may cover the entire side surface of the first cell 2. The insulating member 4 may further cover at least part of a side surface of the second cell 3 or cover the entire side surface of the second cell 3. In other words, the insulating member 4 may cover at least part of a side surface the battery element 1.

FIG. 1 illustrates the battery 1000 with a configuration including the battery element 1 and the insulating member 4.

The first cell 2 is a single cell that includes a first positive electrode layer 100, a first negative electrode layer 200, and a first solid electrolyte layer 300 disposed between the first positive electrode layer 100 and the first negative electrode layer 200.

The first positive electrode layer 100 may include a first positive electrode current collector 110 and a first positive electrode active material layer 120.

The first negative electrode layer 200 may include a first negative electrode current collector 210 and a first negative electrode active material layer 220.

The first cell 2 may include the first positive electrode current collector 110, the first positive electrode active material layer 120, the first solid electrolyte layer 300, the first negative electrode active material layer 220, and the first negative electrode current collector 210 in this order.

The second cell 3 may be a single cell including a second positive electrode layer 101, a second negative electrode layer 201, and a second solid electrolyte layer 301 disposed between the second positive electrode layer 101 and the second negative electrode layer 201 as with the first cell 2. The second positive electrode layer 101 may include a second positive electrode current collector 111 and a second positive electrode active material layer 121. The second negative electrode layer 201 may include a second negative electrode current collector 211 and a second negative electrode active material layer 221.

The first cell 2 is electrically connected to the second cell 3. For example, the first cell 2 is connected to the second cell 3 in series while a conductive material is interposed in between. For instance, the first positive electrode layer 100 of the first cell 2 is joined to the second negative electrode layer 201 of the second cell 3 while the conductive material is interposed in between. The first positive electrode current collector 110 and the second negative electrode current collector 211 joined to each other constitute a so-called bipolar electrode in which one end functions as a positive electrode while another end functions as a negative electrode, for example. Although FIG. 1 illustrates the configuration in which the first positive electrode layer 100 of the first cell 2 is joined to the second negative electrode layer 201 of the second cell 3, the first cell 2 and the second cell 3 may be laminated in reverse order. Specifically, the battery 1000 may have a configuration to join the first negative electrode layer 200 of the first cell 2 to the second positive electrode layer 101 of the second cell 3.

The first cell 2 has an outer peripheral shape that includes a first side 21 having the curved portion in plan view. In the battery 1000 according to the first embodiment, the curved portion on the first side 21 is curved outward of the first cell 2.

The first cell 2 may have a flattened rectangular parallelepiped shape as illustrated in FIG. 1, for example. Specifically, the first cell 2 may have a schematic quadrangular shape in plan view as illustrated in FIG. 1(b). That is to say, the first cell 2 has the outer peripheral shape defined by the first side 21, a second side 22, a third side 23, and a fourth side 24 in plan view. Here, the first side 21 may face the third side 23 while the second side 22 may face the fourth side 24. The following description will discuss an example in which the schematic shape of the first cell 2 in plan view is the quadrangle defined by the first to fourth sides. However, the shape of the first cell 2 is not limited to this shape. The outer peripheral shape of the first cell 2 in plan view only needs to include the first side 21 having the curved portion. In this context, the outer peripheral shape may be defined by less than or equal to three sides or greater than or equal to five sides, for example.

The first cell 2 may have the outer peripheral shape in plan view including the first side 21, the second side 22, the third side 23, and the fourth side 24 as illustrated in FIG. 1(a). A typical example of a schematic external shape of the first cell 2 has approximate dimensions of a long side equal to 120 mm, a short side equal to 90 mm, and a thickness equal to 200 μm.

The first cell 2 has the outer peripheral shape including the first side 21 having the curved portion curved outward in plan view. Since the first cell 2 includes the first side 21 having the curved portion as described above, a stress to be applied to the laminated body of the first cell 2 and the second cell 3 such as an external stress is easily absorbed or dispersed. As a consequence, interlayer delamination and cracks in the first cell 2 and the second cell 3 are suppressed and high reliability of the battery 1000 is obtained. Moreover, since the first side 21 is curved outward, corner portions defined by the first side 21 and the second side 22 as well as the fourth side 24 being adjacent sides thereto each form an obtuse angle, whereby concentration of the stress on the corner portions is relaxed. Therefore, according to the above-described configuration, the interlayer delamination and the cracks in the first cell 2 and the second cell 3 are suppressed more properly, and higher reliability of the battery 1000 is obtained. Moreover, according to the above-described configuration, when the insulating member 4 is formed by coating a liquid-based insulating material on the side surface of the first cell 2, for instance, each corner portion is less likely to be exposed from the insulating member 4 in the case of forming the curved surface. Thus, the entire side surface can be covered with the insulating member 4. As a consequence, defects of the insulating member 4 are suppressed and cracks of the insulating member 4 caused by an impact or a cooling-heating cycle are also suppressed. In this way, durability of the insulating member 4 is improved as well.

As described above, the first side 21 of the first cell 2 includes the curved portion that is curved outward of the first cell. As illustrated in FIG. 1, the entire first side 21 of the first cell 2 may be curved outward of the first cell 2, that is to say, curved to project from the center of the first cell 2. Accordingly, in a case of application of a flexural stress, the stress concentrating around the center can be absorbed or dispersed by using deformability of an outer peripheral region of the first cell 2. For example, the battery element 1 itself will be protected by deformation of a projection 21a on the side surface of the battery element 1. In the following description, the projection on the side surface of the battery element 1 may be referred to as a “stepped portion” as appropriate. Accordingly, it is possible to suppress the interlayer delamination in a central region of the battery element 1 and to increase bending resistance.

In the battery 1000 according to the first embodiment, the second cell 3 may have an outer peripheral shape including a side having a curved portion in plan view as with the first cell 2. For example, the outer peripheral shape of the second cell 3 in plan view may be defined by a first side 31, a second side 32, a third side 33, and a fourth side 34. The first side 31 is located at a position corresponding to the first side 21 of the first cell 2. The second side 32 is located at a position corresponding to the second side 22 of the first cell 2. The third side 33 is located at a position corresponding to the third side 23 of the first cell 2. The fourth side 34 is located at a position corresponding to the fourth side 24 of the second cell 3. The third side 33 of the second cell 3 may have a curved portion that is curved outward of the second cell 3 as with the first side 21 of the first cell 2. As illustrated in FIG. 1, the entire third side 33 of the second cell 3 may be curved outward of the second cell 3, that is to say, curved to project from the center of the second cell 3. According to this configuration, the third side 33 of the second cell 3 has the same operation and effect as those of the first side 21 of the first cell 2 described above.

The outer peripheral shape of the first cell 2 in plan view has a portion on the first side 21 that does not coincide with the outer peripheral shape of the second cell 3. In the battery 1000 illustrated in FIG. 1, the first side 21 of the first cell 2 has the shape that is curved outward of the cell whereas the first side 31 of the second cell 3 is formed of a straight line. Hence, the first side 21 of the first cell 2 has a different shape from the first side 31 of the second cell 3 corresponding thereto. Specifically, the battery 1000 according to the first embodiment includes the first cell 2 and the second cell 3 that have different shapes from each other in plan view. Moreover, the outer peripheral shape of the third side 33 of the second cell 3 in plan view has a portion that does not coincide with the outer peripheral shape of the first cell 2. In the battery 1000 illustrated in FIG. 1, the third side 33 of the second cell 3 has the shape curved outward of the cell whereas the third side 23 of the first cell 2 is straight. Hence, the third side 33 of the second cell 3 has a different shape from the third side 23 of the first cell 2 corresponding thereto. As mentioned above, the battery 1000 according to the first embodiment includes the first cell 2 and the second cell 3 that have different shapes from each other in plan view.

In the battery 1000 illustrated in FIG. 1, the first side 21 of the first cell 2 and the third side 33 of the second cell 3 located at a position facing the first side 21, which constitute the battery element 1, are curved in such a way as to project outward from the cells. The first side 21 of the first cell 2 is formed from a curved line, which connects two ends of the first side 21 to a point where a minimum distance from a straight line connecting the two ends reaches a maximum. The third side 33 of the second cell 3 is formed from a curved line, which connects two ends of the third side 33 to a point where a minimum distance from a straight line connecting the two ends reaches a maximum. When the point on the first side 21 of the first cell 2 where the minimum distance from the straight line connecting the two ends of the first side 21 reaches the maximum is defined as a maximum projecting point of the first side 21, the minimum distance between the straight line and the maximum projecting point may be substantially equal to or greater than a thickness of the first cell 2. When the point on the third side 33 of the second cell 3 where the minimum distance from the straight line connecting the two ends of the third side 33 reaches the maximum is defined as a maximum projecting point of the third side 33, the minimum distance between the straight line and the maximum projecting point may be substantially equal to or greater than a thickness of the second cell 3. Regarding each curved side, a distance to the point having the largest minimum distance from the straight line connecting the two ends of the side will be described as a “projecting width” of the side in the following description. Since the first side 21 of the first cell 2 and the second side of the second cell 3 are curved as described above, the battery element 1 can be provided with the configuration in which the side surface of the first cell 2 or the side surface of the second cell 3 is the curved surface, and the side surface of the battery element 1 formed from the side surface of the first cell 2 and the side surface of the second cell 3 has steps. According to the above-described side surface structure of the battery element 1 having the steps, the stress to be applied to a region of the battery element 1 that is susceptible to breakage in case of application of the stress can be absorbed or dispersed to the surrounding area, thereby protecting the battery element 1. Here, the region of the battery element 1 susceptible to breakage in case of application of the stress is a central portion of each side and a portion around the central portion, for example.

The first side 21 of the first cell 2 and the third side 33 of the second cell 3 that are curved outward of the cells may smoothly project outward in an arc shape in plan view. Regarding the straight line and the curved line connecting the two ends of the first side 21 of the first cell 2, the position of the curved line that is most distant from the straight line may be located on a perpendicular bisector of the straight line connecting the two ends of the first side 21, for example. However, the present disclosure is not limited to this configuration. Regarding the straight line and the curved line connecting the two ends of the third side 33 of the second cell 3, the position of the curved line that is most distant from the straight line may be located on a perpendicular bisector of the straight line connecting the two ends of the third side 33, for example. However, the present disclosure is not limited to this configuration. The projecting width of the first side 21 of the first cell 2 is not limited to a particular value. Reliability of the battery 1000 can be improved by causing the first side 21 to be curved and project only a little from the straight line connecting the two ends of the first side 21. For example, the projecting width may be set in a range from 20 μm to 2 mm. For example, the reliability of the battery 1000 can be further improved by setting the projecting width of the first side 21 of the first cell 2 greater than the thickness of the first cell 2. The projecting width of the third side 33 of the second cell 3 is not limited to a particular value. Reliability of the battery 1000 can be improved by causing the third side 33 to be curved and project only a little from the straight line connecting the two ends of the third side 33. For example, the reliability of the battery 1000 can be further improved by setting the projecting width of the third side 33 of the second cell 3 greater than the thickness of the second cell 3.

Although the description has been given here of the example in which the entire first side 21 of the first cell 2 is curved, the curved portion may instead be formed by curving part of the first side 21. Specifically, the third side 33 may be formed from a curved portion and the remaining straight portion. While the battery 1000 represents a configuration example in which only the first side 21 of the first cell 2 includes the curved portion, at least one side selected from the group consisting of the second side 22, the third side 23, and the fourth side 24 may be curved as with the first side 21. Likewise, regarding the second cell 3, the curved portion may instead be formed by curving part of the third side 33. Specifically, the third side 33 may be formed from a curved portion and the remaining straight portion. While the battery 1000 represents the configuration example in which only the third side 33 of the second cell 3 includes the curved portion, at least one side selected from the group consisting of the first side 31, the second side 32, and the fourth side 34 may be curved as with the third side 33. These configurations can also achieve the effect of improvement in reliability of the battery 1000 obtained by curving the first side 21 of the first cell 2 and the third side 33 of the second cell 3.

When the projecting width of the first side 21 is greater than the thickness of the first cell 2, it is possible to absorb a variation in inclination of the side surface to be brought about in the course of cutting the cells in a manufacturing process. Thus, the step can be formed easily by joining the first cell 2 to the second cell 3. As a consequence, the external stress can be appropriately absorbed or dispersed.

As described above, by curving at least part of the outer periphery of the battery element 1 so as to project outward and providing the side surface with the step between the cells, deformability is imparted to each projecting region so that the external stress such as a bending stress can be absorbed or dispersed. Even when a strong stress is applied to the battery 1000, the projecting region preferentially develops cracks and such cracks are less likely to propagate into the step. In other words, the battery element 1 is protected so that apparent characteristic degradation can be suppressed. In the case where the battery element 1 has the smoothly curved side surface, for example, local concentration of the stress is suppressed more effectively. Hence, the large stress to be applied to the battery 1000 is easily absorbed or dispersed by using the projecting region. Accordingly, breakage of the battery element 1 and delamination between the layers (between the first cell 2 and the second cell 3, for example) therein are less likely to occur. For this reason, the interlayer delamination and cracks originating from the side surface of the battery element 1 can be suppressed more appropriately. As a consequence, the battery 1000 can achieve high reliability even when the battery 1000 is formed into a thin-layered and large-sized battery.

The insulating member 4 covers at least part of the side surface of the first cell 2, for example. As illustrated in FIG. 1, the insulating member 4 may cover the entire side surface of the first cell 2. The insulating member 4 may further cover at least part of the side surface of the second cell 3 or cover the entire side surface of the second cell 3.

The insulating member 4 may cover an outer peripheral side surface of the battery element 1 and may be fixed thereto, for example.

In a desirable mode of the insulating member 4, the insulating member 4 is provided to the outer peripheral surfaces of both the first cell 2 and the second cell 3, in particular, to the side surfaces on which stepped portions 21a and 33a are formed. To be more precise, the insulating member 4 desirably covers the outer peripheral surfaces of the first cell 2 and the second cell 3, and covers the outer peripheral surfaces across the stepped portions 21a and 33a of the two cells on the surfaces corresponding to the first side 21 of the first cell 2 and the third side 33 of the second cell 3. By covering the curved steps on the side surfaces with the insulating member 4 as described above, a junction area between the insulating member 4 and the battery element 1 is increased. Moreover, a strong anchoring effect of the insulating member 4 to a ridge line of the step (that is, a corner portion of the step) is added. Due to the workings mentioned above, the insulating member 4 is tightly joined to the side surface of the battery element 1.

The first side 21 and the third side 33 that are curved outward of the cells are smoothly curved and covered with the insulating member 4 without being exposed from the insulating member 4. Accordingly, interlayer delamination inside the cell (such as interlayer delamination of the current collector from the active material layer), which is prone to occur at the portion projecting outward from each of the first side 21 and the third side 33 that are curved, is suppressed by strong fixation of the insulating member 4 to the side surface of the battery element 1. The above-mentioned interlayer delamination is prone to originate from the remotest point on the first side 21 from the straight line connecting the two ends of this side and from the remotest point on the third side 33 from the straight line connecting the two ends of this side in particular. However, since the insulating member 4 covers the side surfaces of the battery element 1, an outer rim of the battery 1000 can be firmly reinforced by a high fixation action in addition to the absorption or dispersion of the external stress.

In the battery 1000, the steps on the side surfaces that constitute the first side 21 and the third side 33, which are formed by joining the first cell 2 to the second cell 3, absorb or disperse the external stress. Moreover, the insulating member 4 covers the side surfaces of the battery element 1 and is strongly fixed to the side surfaces of the battery element 1. According to the above-described configuration, a stress that may concentrate on central portions of the first side 21 of the first cell 2 and of the third side 33 of the second cell 3 in the case of application of the flexural stress to the battery 1000, for example, can be absorbed by the deformation of the step on the side surfaces of the battery element 1 or dispersed to the surrounding area thereof. The insulating member 4 strongly fixes and reinforces the cells as well as the layers in the cells, thereby increasing delamination resistance and bending resistance between the layers (between the layers of the current collector and the active material layer, for example) in the cell. As described above, the battery 1000 according to the first embodiment can be stronger and achieve higher reliability even in the case of being formed into the thin-layered and large-sized battery.

Now, respective constituents of the battery 1000 will be described below in detail with reference to FIG. 1.

### Battery Element 1

As described above, the battery element 1 includes the first cell 2 and the second cell 3. The second cell is laminated on the first cell.

In the battery 1000, the first side 21 of the first cell 2 and the third side 33 of the second cell 3 facing the first side 21 may be curved outward from the center of the cells and may each project at a larger width than a cell thickness (such as 200 μm) from the straight line that connects the two ends of each side. When the projecting width is larger than the thickness, the variation in inclination of the side surface of the actual cell is absorbed by this projecting width, for instance. Hence, the effect of the battery of the present disclosure can be manifested more distinctively. In a manufacturing process, for instance, a joined body is produced by pressurizing and integrating the first positive electrode layer 100, the first solid electrolyte layer 300, and the first negative electrode layer 200. Then, the cell is obtained by cutting the joined body in the pressurized state into a prescribed shape with a cutting blade (so-called a Thomson blade). The cutting blade is generally configured to have a sharp tip end and to be gradually thickened with distance from the tip end (namely, a V-shape). For this reason, a cut surface of the joined body being cut with the cutting blade, namely, the side surface of the cell is not always perpendicular with respect to the principal surface but may instead be inclined in some cases. Although it depends on a cutting method as well as hardness, thickness, and other properties of the laminated body, an inclination as large as a thickness of the joined body may be formed at the cut surface of the joined body. Note that the inclination to be formed at the cut surface means a deviation width from a perpendicular plane. Accordingly, since the projecting width is larger than the thickness of the cell, it is possible to absorb the variation in inclination on the cut surface formed on the side surface of the cell, thereby causing the side surface to project more reliably. According to this configuration, the battery 1000 of the first embodiment can manifest the effect of the battery of the present disclosure more distinctively.

In the battery 1000 according to the first embodiment, the battery element 1 is formed from the first cell 2 and the second cell 3. Instead, the battery element 1 may have a structure formed by laminating three or more cells (single batteries).

The first cell 2 and the second cell 3 constituting the battery element 1 may be connected in series or connected in parallel.

The schematic shape in plan view of each of the first positive electrode current collector 110, the first positive electrode active material layer 120, the first solid electrolyte layer 300, the first negative electrode active material layer 220, and the first negative electrode current collector 210 collectively constituting the first cell 2 is a quadrangle, for example. Although the shape in plan view of each of the first positive electrode current collector 110, the first positive electrode active material layer 120, the first solid electrolyte layer 300, the first negative electrode active material layer 220, and the first negative electrode current collector 210 is not limited, the shape may be a quadrangle defined by four sides. The quadrangle may be a quadrangle with right angles such as a square and a rectangle. However, the “quadrangle” stated herein means an approximate quadrangle since the first side 21 of the first cell 2 includes the curved portion. In the battery 1000 illustrated in FIG. 1, the first positive electrode current collector 110, the first positive electrode active material layer 120, the first solid electrolyte layer 300, the first negative electrode active material layer 220, and the first negative electrode current collector 210 constituting the first cell 2 have mutually the same size and contours of these constituents coincide with one another in plan view. However, the present disclosure is not limited to this configuration. For example, the first positive electrode active material layer 120 may be smaller than the first negative electrode active material layer 220. The first positive electrode active material layer 120 and the first negative electrode active material layer 220 may be smaller than the first solid electrolyte layer 300. For instance, part of the first solid electrolyte layer 300 may be in contact with at least one of the first positive electrode current collector 110 or the first negative electrode current collector 210.

Each principal surface of the battery element 1 has a schematic quadrangular shape in plan view, for example. The shape of the battery element 1 may be a flattened schematic quadrangular shape, for example. The flattened shape means that a width in the thickness direction is smaller than a width in a surface direction. The schematic quadrangle may be a shape formed by cutting four corners of the quadrangle, which is so-called a chamfered shape.

The first positive electrode layer 100 does not always have to include the first positive electrode current collector 110. Alternatively, the first negative electrode layer 200 does not always have to include the first negative electrode current collector 210. In the case where two or more cells are laminated, for example, an electrode layer of one of the adjacent cells does not always have to include a current collector. In this case, an active material layer may be provided on two surfaces of one current collector such that the current collector in one of the cells also functions as the current collector of the other cell.

The schematic shape in plan view of each of the second positive electrode current collector 111, the second positive electrode active material layer 121, the second solid electrolyte layer 301, the second negative electrode active material layer 221, and the second negative electrode current collector 211 collectively constituting the second cell 3 is a quadrangle, for example. Although the shape in plan view of each of the second positive electrode current collector 111, the second positive electrode active material layer 121, the second solid electrolyte layer 301, the second negative electrode active material layer 221, and the second negative electrode current collector 211 is not limited, the shape may be a quadrangle defined by four sides. The quadrangle may be a quadrangle with right angles such as a square and a rectangle. However, as with the case of the first cell 2, the “quadrangle” stated herein means an approximate quadrangle. Accordingly, the second cell 3 may be considered as the quadrangle even when the third side 33 of the second cell 3 is curved.

In the battery 1000 illustrated in FIG. 1, the second positive electrode current collector 111, the second positive electrode active material layer 121, the second solid electrolyte layer 301, the second negative electrode active material layer 221, and the second negative electrode current collector 211 constituting the second cell 3 have mutually the same size and contours of these constituents coincide with one another in plan view. However, the present disclosure is not limited to this configuration. For example, the second positive electrode active material layer 121 may be smaller than the second negative electrode active material layer 221. The second positive electrode active material layer 121 and the second negative electrode active material layer 221 may be smaller than the second solid electrolyte layer 301. For instance, part of the second solid electrolyte layer 301 may be in contact with at least one of the second positive electrode current collector 111 or the second negative electrode current collector 211.

In the following description, each of the first positive electrode active material layer 120 and the first negative electrode active material layer 220 will also be simply referred to as a “first active material layer”. Meanwhile, each of the first positive electrode current collector 110 and the first negative electrode current collector 210 will also be simply referred to as a “first current collector”. Each of the second positive electrode active material layer 121 and the second negative electrode active material layer 221 will also be simply referred to as a “second active material layer”. Each of the second positive electrode current collector 111 and the second negative electrode current collector 211 will also be simply referred to as a “second current collector”. In the meantime, each of the first positive electrode active material layer 120, the first negative electrode active material layer 220, the second positive electrode active material layer 121, and the second negative electrode active material layer 221 will also be simply referred to as an “active material layer. Each of the first positive electrode current collector 110, the first negative electrode current collector 210, the second positive electrode current collector 111, and the second negative electrode current collector 211 will also be simply referred to as a “current collector”. Each of the first solid electrolyte layer 300 and the second solid electrolyte layer 301 will also be simply referred to as a “solid electrolyte layer”.

The current collector only needs to be formed from a conductive material and such a material is not limited to a particular substance. Examples of the material of the first current collector and the second current collector include stainless steel, nickel (Ni), aluminum (Al), iron (Fe), titanium (Ti), copper (Cu), palladium (Pd), gold (Au), platinum (Pt), and an alloy of two or more of the above-mentioned metal elements. A foil-like body, a plate-like body, or a mesh-like body of any of these materials can be used as the current collector.

The material of the current collector may be appropriately selected in consideration of a manufacturing process, indissolubility and indecomposability at a used temperature and a used pressure, and an operating electric potential as well as conductivity of the battery adopting the current collector. The material of the current collector may also be selected depending on tensile strength or heat resistance required. The current collector may be a high-strength electrolytic copper foil or a clad material obtained by laminating different types of metal foils.

A thickness of the current collector may be set greater than or equal to 10 μm and less than or equal to 100 μm, for example.

A surface of the current collector may be processed into a roughened surface with asperities in order to increase adhesion to the first active material layer.

An adhesive component such as organic binder may be coated on the surface of the current collector. In this way, adhesion at an interface between the first current collector and another layer is reinforced, so that mechanical and thermal reliability, cycle characteristics, and the like of the battery 1000 can be improved.

The first active material layer is disposed between the first current collector and the first solid electrolyte layer. To be more precise, the first active material layer is disposed in contact with the principal surface on the first solid electrolyte layer side of the first current collector. The first active material layer may cover the entire principal surface of the first current collector. The second active material layer is disposed between the second current collector and the second solid electrolyte layer. To be more precise, the second active material layer is disposed in contact with the principal surface on the second solid electrolyte layer side of the second current collector. The second active material layer may cover the entire principal surface of the second current collector.

The first positive electrode active material layer 120 and the second positive electrode active material layer 121 contain a positive electrode active material. The positive electrode active material is a material in which metal ions such as lithium (Li) ions and magnesium (Mg) ions are inserted into or extracted out of a crystal structure at a higher electric potential than that of the negative electrode, and oxidation or reduction is performed in association therewith.

The positive electrode active material may be a compound containing lithium and a transition metal element. To be more precise, the positive electrode active material may be an oxide containing lithium and the transition metal element or a phosphate compound containing lithium and the transition metal element. Examples of the oxide containing lithium and the transition metal element include a lithium nickel composite oxide such as LiNiₓM₁₋ₓO₂ (in which M is at least one element selected from the group consisting of Co, Al, Mn, V, Cr, Mg, Ca, Ti, Zr, Nb, Mo, and W and x satisfies 0<x≤1), a layered oxide such as lithium cobaltate (LiCoO₂), lithium nickelate (LiNiO₂), and lithium manganate (LiMn₂O₄), and lithium manganate (LiMn₂O₄, Li₂MnO₃, or LiMnO₂) having a spinel structure. Meanwhile, lithium iron phosphate (LiFePO₄) having an olivine structure is an example of the phosphate compound containing lithium and the transition metal element. The positive electrode active material may be sulfur (S) or a sulfide such as lithium sulfide (Li₂S). In this case, a material prepared by coating or adding lithium niobate (LiNbO₃) and the like onto positive electrode active material particles can be used as the positive electrode active material. The positive electrode active material may adopt only one of these materials or a combination of two or more of these materials.

A thickness of each of the first positive electrode active material layer 120 and the second positive electrode active material layer 121 may be greater than or equal to 5 μm and less than or equal to 300 ∞m, for example.

The first negative electrode active material layer 220 and the second negative electrode active material layer 221 contain a negative electrode active material. The negative electrode active material is a material in which metal ions such as lithium (Li) ions and magnesium (Mg) ions are inserted into or extracted out of a crystal structure at a lower electric potential than that of the positive electrode, and oxidation or reduction is performed in association therewith.

A carbon material such as natural graphite, artificial graphite, graphite carbon fibers, and resin heat-treated carbon, or an alloy material that is formed into a compound together with the solid electrolyte is an example of the negative electrode active material. Examples of the alloy material include a lithium alloy such as LiAl, LiZn, Li₃Bi, Li₃Cd, Li₃Sb, Li₄Si, Li_{4.4}Pb, Li_{4.4}Sn, Li_{0.17}C, and LiC6, an oxide of lithium and a transition metal element such as lithium titanate (Li₄Ti₅O₁₂), and a metal oxide such as zinc oxide (ZnO) and silicon oxide (SiOₓ). The negative electrode active material may adopt only one of these materials or a combination of two or more of these materials.

A thickness of each of the first negative electrode active material layer 220 and the second negative electrode active material layer 221 may be set greater than or equal to 5 μm and less than or equal to 300 μm, for example.

The active material layer may contain not only the active material but also an additive material. Examples of the additive material include a solid electrolyte such as an inorganic solid electrolyte and an organic solid electrolyte, a conductive assistant such as acetylene black, and a binder such as polyethylene oxide and polyvinylidene fluoride. By blending the active material and the additive material at a prescribed ratio, it is possible to improve ion conductivity in the active material layer and to improve electron conductivity at the same time.

The first solid electrolyte layer 300 is disposed between the first positive electrode active material layer 120 and the first negative electrode active material layer 220. The first solid electrolyte layer 300 may be in direct contact with the first positive electrode active material layer 120 and the first negative electrode active material layer 220. The second solid electrolyte layer 301 is disposed between the second positive electrode active material layer 121 and the second negative electrode active material layer 221. The second solid electrolyte layer 301 may be in direct contact with the second positive electrode active material layer 121 and the second negative electrode active material layer 221.

The solid electrolyte layer contains a solid electrolyte.

The solid electrolyte only needs to be a publicly known solid electrolyte for battery use having ion conductivity. A solid electrolyte that conducts metal ions such as lithium ions and magnesium ions can be used as the solid electrolyte, for example.

The solid electrolyte may also be a sulfide-based solid electrolyte. Examples of the sulfide-based solid electrolyte include Li₂S-P₂S₅-based, Li₂S-SiS₂-based, Li₂S-B₂S₃-based, Li₂S-GeS₂-based, Li₂S-SiS₂-LiI-based, Li₂S-SiS₂-Li₃PO₄-based, Li₂S-Ge₂S₂-based, Li₂S-GeS₂-P₂S₅-based, and Li₂S-Ge_{S}2-ZnS-based lithium-containing sulfides.

The solid electrolyte may also be an oxide-based solid electrolyte. Examples of the oxide-based solid electrolyte include a lithium-containing metal oxide such as Li₂O-SiO₂ and Li₂O-SiO₂-P₂O₅, a lithium-containing metal nitride such as LiₓP_{y}O_{1-z}N_{z}, lithium phosphate (Li₃PO₄), and a lithium-containing transition metal oxide such as lithium titanium oxide.

The solid electrolyte may adopt only one of the above-mentioned materials or a combination of two or more of these materials.

The solid electrolyte may have lithium-ion conductivity.

The solid electrolyte layer may contain not only the solid electrolyte but also a binder. Examples of the binder include polyethylene oxide and polyvinylidene fluoride.

A thickness of the solid electrolyte layer may be set greater than or equal to 5 μm and less than or equal to 150 μm, for example.

The solid electrolyte layer may be formed from an aggregate of the solid electrolyte particles. The solid electrolyte layer may be formed from a sintered structure of the solid electrolyte.

### Insulating Member 4

As described above, the insulating member 4 covers at least part of the side surface of the battery element 1. The insulating member 4 may cover at least part of the side surface of the first cell 2. The insulating member 4 may cover at least part of the side surface of the first cell 2 and also cover at least part of the side surface of the second cell 3.

The insulating member 4 desirably covers the side surface of the battery element 1 as large as possible. For example, the insulating member 4 may cover the entire side surface of the battery element 1 as illustrated in FIG. 1. In other words, the side surface of the battery element 1 does not have to be exposed. To be more precise, regarding the first cell 2 and the second cell 3 being the single cells collectively constituting the battery element 1, the insulating member 4 may cover across end surfaces of the current collectors, end surfaces of the active material layers, end surfaces of the solid electrolyte layers, and the stepped portions 21a and 33a provided to the first side 21 and the third side 33 of the respective cells. Accordingly, the side surfaces of the first side and the third side of the battery element 1 are covered with an insulating resin. Here, the side surface of the first side of the battery element 1 corresponds to the side surface including the first side 21 of the first cell 2 and the first side 31 of the second cell 3. Meanwhile, the side surface of the third side of the battery element 1 corresponds to the side surface including the third side 23 of the first cell 2 and the third side 33 of the second cell 3. Accordingly, the insulating member 4 that covers the side surfaces of the battery element 1 along the stepped portions 21a and 33a each formed due to the difference in shape between the side having the curved portion being curved outward of the cell and the straight side functions as an anchor that is strongly fixed, whereby strong fixation between the first cell 2 and the second cell 3 is obtained. According to the above-described configuration, the fixation of the battery element 1 is reinforced so that the battery 1000 having a high tolerance for external stresses and having high reliability can be obtained. In the meantime, when a liquid-based (such as an epoxy resin-based) insulating material frequently used for industrial purposes is coated on a corner portion of a quadrangle, for instance, a peak of the corner portion is prone to exposure due to concentration of surface tension thereon. For this reason, it is considered to be difficult to cover the corner portion with the insulating material flawlessly. However, by providing the side surfaces with the steps as in the battery 1000 according to the first embodiment, the stepped portions 21a and 33a can disperse energy concentrating on the surfaces at the peaks of the corner portions, thereby easily covering four corner portions of the principal surface of the battery element 1. Thus, the corner portions of the battery element 1 can be covered with the insulating material, so that a mechanical stress on each corner portion can be reduced, thereby reducing a risk of a short circuit due to a deformation or the active material that falls off. In this way, it is possible obtain the battery having higher reliability.

When the active material on the side surface falls off due to an impact on any of the stepped portions 21a and 33a of the battery element 1, the active material may remain on the stepped portions 21a and 33a and possibly come into contact with the positive electrode layer or the negative electrode layer to cause a short circuit. The aforementioned short circuit attributed to the active material that falls off can also be suppressed by continuously covering the side surfaces of the battery element 1 together with the stepped portions 21a and 33a by using the insulating member 4. Here, recesses of the stepped portions 21a and 33a are also filled with the insulating member 4 that covers the stepped portions 21a and 33a. Thus, an effect of reinforcing a framework structure of the battery element 1 is also obtained. Accordingly, the battery element 1 is also robust over the detachment and bending such as deflection. When a liquid-based epoxy resin is used as the material of the insulating member 4, an electrical insulation property can be increased sufficiently by setting a thickness of the insulating member 4 greater than or equal to 10 μm. Moreover, it is possible to improve impact absorbency by setting the thickness of the insulating member 4 greater than or equal to 100 μm, for example. The thickness of the insulating member 4 may be changed as appropriate depending on the material type of the insulating member 4. Shielding performances against atmosphere and moisture can be improved by setting the thickness of the insulating member 4 greater than or equal to 1 mm, for instance. Although an upper limit of the thickness of the insulating member 4 is not specified, the insulating member 4 may be set to an appropriate thickness depending on its use application in order to suppress degradation of energy density or volumetric capacitance density of the battery 1000.

A larger thickness of the insulating member 4 can achieve higher reliability. On the other hand, the larger thickness naturally causes a volume increase. Accordingly, it is desirable to appropriately set the thickness of the insulating member 4 at a required level in light of achieving both the capacity and energy density of the battery 1000 and the reliability thereof.

The material of the insulating member 4 only needs to be an electrical insulator. A typical example of such a material is an insulating resin. Examples of the insulating resin include an epoxy resin, an acrylic resin, a polyimide resin, and a silsesquioxane. The insulating resin may be a liquid-based or powder-based thermosetting epoxy resin. Such a resin is coatable. By coating the coatable thermosetting resin in a liquid form or in a powder form onto the side surface of the battery element 1 and then thermally curing the resin, the insulating member 4 can cover and fix the side surface of the battery element 1.

The insulating member 4 does not always have to contain the resin. For example, the insulating member 4 may be formed from an insulating inorganic material. Alumina is a typical example of such an inorganic material.

The insulating member 4 may be formed from two or more materials. For example, the respective sides of the first cell 2 may be covered with the insulating material that is different from the insulating material that covers the respective sides of the second cell 3.

The insulating member 4 may have a structure formed by laminating two or more insulating layers. The insulating members constituting the two or more insulating layers may be made of the same material or different materials. That is to say, a different insulating material may be used for each layer in the course of forming the insulating layers two or more times. By laminating the insulating layers while repeating coating and curing the insulating layers in the descending order of curing temperatures, melting points, or glass-transition temperatures of the insulating resins, for example, it is possible to form the dense and thick insulating member 4 without degrading the properties of the insulating layers formed earlier with the heat at the time of curing. In this case, the insulating layer located more outward has the higher curing temperature, melting point, or glass-transition temperature of the resin contained therein. Here, as for thermal curing conditions, the temperature and the time may be set within ranges not adversely affecting battery properties.

The insulating member 4 may be softer than the solid electrolyte layer and the active material layer. The insulating member 4 may be softer than the current collector. For example, a common epoxy material having an elastic modulus greater than or equal to 10 GPa and less than or equal to 40 GPa can be used as the insulating member 4. According to the above-described configuration, it is possible to absorb an impact on a region covered with the insulating member 4, and to protect the battery 1000 while maintaining reliability of a joint interface. Moreover, even when a cooling-heating cycle takes place, the soft insulating member 4 absorbs the stress applied to the interface with the insulating member 4, which is attributed to differences in thermal expansion at both temperature ends relative to the metal (the current collectors) having a large thermal expansion coefficient in particular. Accordingly, in the structure having the step on the side surface of the battery element 1 formed by joining the cell having the curved side to the cell having the straight side, it is possible to maintain the coated structure with the insulating member 4 while suppressing adverse effects such as the occurrence of cracks.

Correlations of softness of the insulating member 4 relative to the current collector, the active material layer, and the solid electrolyte layer can be determined as with Vickers hardness measurement by thrusting a rigid indenter against measurement targets and comparing magnitude relations of scars thus formed. For example, when the indenter is thrust against respective regions on the section of the battery element 1 as well as the insulating member 4 by applying the same force, the insulating member 4 will be dented most among other regions.

The above-mentioned relations of softness may be satisfied throughout an operating temperature range of the battery 1000. In general, the hardness of the resin contained in the insulating member 4 tends to be higher as the temperature is lower. Accordingly, the insulating member 4 only needs to be softer than the solid electrolyte layer and the active material layer at a temperature lower than or equal to a low-temperature limit of the operating temperature range. The insulating member 4 may be softer than the solid electrolyte layer and the active material layer at a low temperature in a range from 0° C. to −25° C., for example. This configuration can notably increase a cooling-heating cycle resistance performance of the battery 1000.

The insulating member 4 may cover not only the side surface of the battery element 1, but also part of each of the two principal surfaces (namely, an upper surface and a lower surface) of the battery element 1. The insulating member 4 may be annularly provided along a rim of each principal surface of the battery element 1. Operation and effect of more firmly joining the current collectors to the respective layers of the battery element 1 are obtained by partially covering the principal surfaces of the battery element 1 with the insulating member 4 as described above. For example, it is possible to suppress delamination of the current collector or the respective layers of the battery element 1 due to the external stress such as cooling and heating stresses. In particular, it is also possible to firmly fix a central portion of the side surface of the battery element 1, which is prone to delamination, against the flexural stress that is often problematic in the case of the large-sized cell. This configuration improves deflection resistance of the battery 1000.

As described above, the battery 1000 according to the first embodiment includes the first cell 2 and the second cell 3 that is laminated on the first cell 2 and has the different outer peripheral shape from that of the first cell 2 in plan view. Moreover, the first side 21 of the first cell 2 is curved. Thus, it is possible to relax the external stress such as the bending stress applied to the battery 1000 by dispersing the stress and the like. In addition, the above-described configuration can suppress the interlayer delamination and cracks originating from the side surface of the battery element 1. Therefore, the battery 1000 can achieve high reliability even when the battery 1000 is formed from thinner layers and is increased in size. Meanwhile, the battery 1000 according to the first embodiment may be configured to curve the third side 33 of the second cell 3 at the position facing the first side 21 of the first cell 2. This configuration can further improve the reliability of the battery 1000.

The battery 1000 according to the first embodiment may further have the configuration in which the stepped portion 21a on the side surface of the battery element 1 formed by providing the first side 21 of the first cell 2 with the curved portion is covered with the insulating member 4. According to this configuration, a space between the first cell 2 and the second cell 3 as well as spaces between the layers constituting the respective cells are firmly integrated together, and the reliability of the battery 1000 can be further improved. In addition, the above-described insulating member 4 can also achieve an operation to reinforce the shape of the battery 1000 and an operation to suppress short circuits. Accordingly, it is possible to realize the battery 1000, which is prone not only to develop short circuits but also to cause breakage or defectiveness from a structural perspective, to be thin-layered and large -sized. Thus, the battery 1000 with high energy density and high reliability is obtained.

### Second Embodiment

A battery according to a second embodiment will be described below. Note that the matters that have been explained in the first embodiment may be omitted as appropriate.

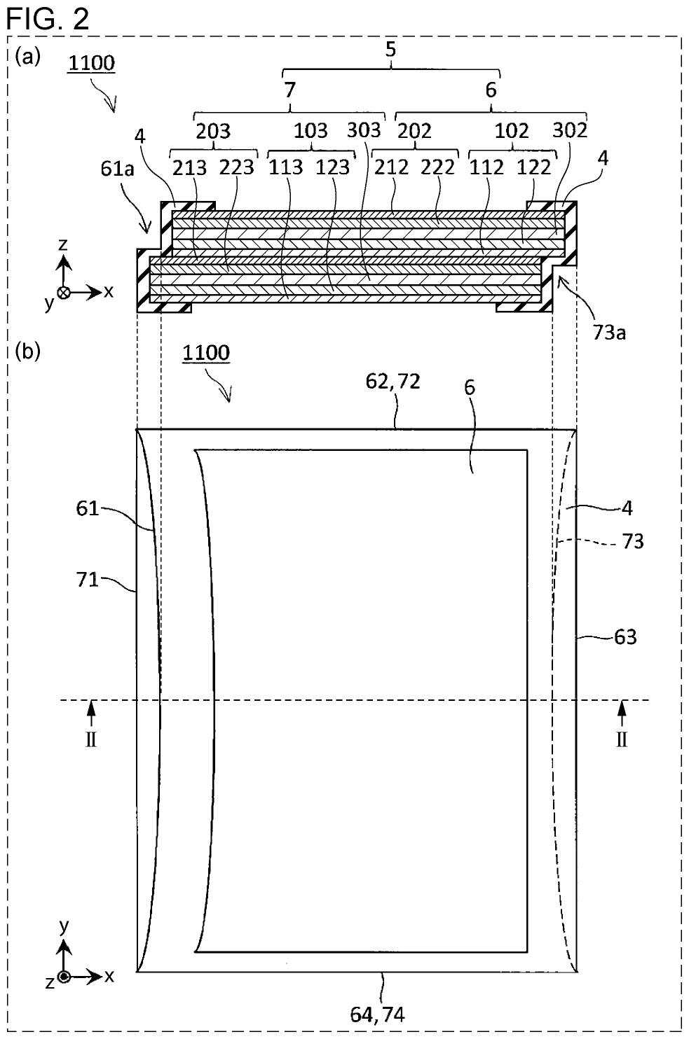

FIG. 2 illustrates a sectional view and a plan view depicting a schematic configuration of a battery 1100 according to the second embodiment. FIG. 2(a) is the sectional view illustrating the schematic configuration of the battery 1100 according to the second embodiment. FIG. 2(b) is the plan view illustrating the schematic configuration of the battery 1100 viewed from a positive side in the z-axis direction. FIG. 2(a) illustrates the section taken at a location indicated by line II-II in FIG. 2(b).

The battery 1100 includes a first cell 6 and a second cell 7. The first cell 6 and the second cell 7 are laminated on each other. In the battery 1100, a laminated body of the first cell 6 and the second cell 7 constitutes a battery element 5.

The first cell 6 is a single cell that includes a first positive electrode layer 102, a first negative electrode layer 202, and a first solid electrolyte layer 302 disposed between the first positive electrode layer 102 and the first negative electrode layer 202. The first positive electrode layer 102 may include a first positive electrode current collector 112 and a first positive electrode active material layer 122. The first negative electrode layer 202 may include a first negative electrode current collector 212 and a first negative electrode active material layer 222. The first cell 6 may include the first positive electrode current collector 112, the first positive electrode active material layer 122, the first solid electrolyte layer 302, the first negative electrode active material layer 222, and the first negative electrode current collector 212 in this order.

The second cell 7 may be a single cell including a second positive electrode layer 103, a second negative electrode layer 203, and a second solid electrolyte layer 303 disposed between the second positive electrode layer 103 and the second negative electrode layer 203 as with the first cell 6. The second positive electrode layer 103 may include a second positive electrode current collector 113 and a second positive electrode active material layer 123. The second negative electrode layer 203 may include a second negative electrode current collector 213 and a second negative electrode active material layer 223.

The first cell 6 is electrically connected to the second cell 7. For example, the first cell 6 is connected to the second cell 7 in series while a conductive material is interposed in between. For instance, the first positive electrode layer 102 of the first cell 6 is joined to the second negative electrode layer 203 of the second cell 7 while the conductive material is interposed in between. The first positive electrode current collector 112 and the second negative electrode current collector 213 joined to each other constitute a so-called bipolar electrode in which one end functions as a positive electrode while another end functions as a negative electrode. Although FIG. 2 illustrates the configuration in which the first positive electrode layer 102 of the first cell 6 is joined to the second negative electrode layer 203 of the second cell 7, the first cell 6 and the second cell 7 may be laminated in reverse order. Specifically, the battery 1100 may have a configuration to join the first negative electrode layer 202 of the first cell 6 to the second positive electrode layer 103 of the second cell 7.

The first cell 6 has an outer peripheral shape that includes a first side 61 having a curved portion in plan view. In the battery 1100 according to the second embodiment, the curved portion on the first side 61 is curved inward of the first cell 6. As illustrated in FIG. 2, the entire first side 61 of the first cell 6 may be curved inward of the first cell 6, that is to say, curved to recede toward the center of the first cell 6. The first cell 6 may have a schematic quadrangular shape in plan view as illustrated in FIG. 2(b). That is to say, the first cell 6 has an outer peripheral shape defined by the first side 61, a second side 62, a third side 63, and a fourth side 64 in plan view. Here, the first side 61 may face the third side 63 while the second side 62 may face the fourth side 64. The following description will discuss an example in which the schematic shape of the first cell 6 in plan view is the quadrangle defined by the first to fourth sides. However, the shape of the first cell 6 is not limited to this shape. The outer peripheral shape of the first cell 6 in plan view only needs to include the first side 61 having the curved portion. In this context, the outer peripheral shape may be defined by less than or equal to three sides or greater than or equal to five sides, for example.

The second cell 7 may have an outer peripheral shape that includes a third side 73 having a curved portion in plan view. In the battery 1100 according to the second embodiment, the curved portion on the third side 73 is curved inward of the second cell 7. As described above, in the battery 1100 according to the second embodiment, the second cell 7 may have the outer peripheral shape that includes the side having the curved portion in plan view as with the first cell 6. For example, the outer peripheral shape of the second cell 7 in plan view may be defined by a first side 71, a second side 72, the third side 73, and a fourth side 74. The first side 71 is located at a position corresponding to the first side 61 of the first cell 6. The second side 72 is located at a position corresponding to the second side 62 of the first cell 6. The third side 73 is located at a position corresponding to the third side 63 of the first cell 6. The fourth side 74 is located at a position corresponding to the fourth side 64 of the first cell 6. The third side 73 of the second cell 7 may have a curved portion that is curved inward of the second cell 7 as with the first side 61 of the first cell 6. As illustrated in FIG. 2, the entire third side 73 of the second cell 7 may be curved inward of the second cell 7, that is to say, curved to recede toward the center of the second cell 7. Note that the schematic shape of the second cell 7 in plan view is not limited to the quadrangle defined by the first to fourth sides, either. The second cell 7 may be formed from less than or equal to three sides or greater than or equal to five sides, for example.

The first positive electrode current collector 112, the first positive electrode active material layer 122, the first solid electrolyte layer 302, the first negative electrode active material layer 222, and the first negative electrode current collector 212 in the first cell 6 have configurations corresponding to the first positive electrode current collector 110, the first positive electrode active material layer 120, the first solid electrolyte layer 300, the first negative electrode active material layer 220, and the first negative electrode current collector 210 in the first cell 2 described in the first embodiment, respectively. Meanwhile, the second positive electrode current collector 113, the second positive electrode active material layer 123, the second solid electrolyte layer 303, the second negative electrode active material layer 223, and the second negative electrode current collector 213 in the second cell 7 have configurations corresponding to the second positive electrode current collector 111, the second positive electrode active material layer 121, the second solid electrolyte layer 301, the second negative electrode active material layer 221, and the second negative electrode current collector 211 in the second cell 3 described in the first embodiment, respectively.

The battery 1100 may further include the insulating member 4 that covers at least part of a side surface of the first cell 6 as with the battery 1000 according to the first embodiment. The insulating member 4 may cover the entire side surface of the first cell 6. The insulating member 4 may further cover at least part of a side surface of the second cell 7 or cover the entire side surface of the second cell 7. In other words, the insulating member 4 may cover at least part of the side surface of the battery element 5.

As described above, the battery 1100 is different from the battery 1000 according to the first embodiment in that the outer peripheral shapes of the first cell 6 and the second cell 7 in plan view are formed such that the first side 61 of the first cell 6 and the third side 73 of the second cell 7 are curved inward of the cells instead of outward thereof. However, the remaining configurations of the battery 1100 are substantially the same as those of the battery 1000.

Since the battery 1100 includes the first cell 6 and the second cell 7 that have different shapes from each other in plan view as described above, steps (irregularities) are formed on the side surface of the battery 1100 as with the battery 1000 of the first embodiment. Thus, the external stress to be applied to the laminated body of the first cell 6 and the second cell 7 is easily absorbed or dispersed as with the battery 1000 of the first embodiment. As a consequence, it is possible to suppress interlayer delamination and cracks in the first cell 6 and the second cell 7, and thus to obtain high reliability of the battery 1100.

Meanwhile, the first side 61 of the first cell 6 is curved inward of the first cell 6. Accordingly, when a thermal impact is applied to the battery element 5, for example, a stress to be applied in a linear direction from the central region in the cell to a midpoint of the first side 61 on the outer rim will be received by the side surface curved in an arched shape. As a consequence, it is possible to suppress cracks that are apt to develop from the midpoint region of the first side 61 to the central part in the cell. Moreover, by fixing the insulating member 4 to the recessed side surface, it is possible to suppress the interlayer delamination between the cells and inside the cells that would originate from the outer rim of the battery element 5 in the case of application of the flexural stress.

Each of the first side 61 and the third side 73 curved inward of the cells may be smoothly curved in an elliptic arc shape or an arc shape toward the center of a principal surface in plan view of the principal surface as illustrated in FIG. 2(b).

For example, the projecting widths of the first side 61 and the third side 73 may be equal to or greater than the thicknesses of the first cell 6 and the second cell 7, respectively. In each of the first side 61 and the third side 73, the position that is most distant from the straight line connecting the two ends of the relevant side, that is to say, the position to determine the projecting width of each side, may be located on a perpendicular bisector of the straight line, for example. However, the present disclosure is not limited to this configuration. By slightly curving the side relative to the straight line, it is possible to obtain the above-described effect of curving the side, so that the reliability of the battery 1100 can be increased. For example, the reliability of the battery 1100 can be further improved by setting the projecting widths of the first side 61 of the first cell 6 and the third side 73 of the second cell 7 larger than the thicknesses of the first cell 6 and the second cell 7, respectively.

According to the above-described configuration, it is possible to absorb the variation in inclination of the side surface caused in the course of cutting the cells in the manufacturing process. In this way, the occurrence of the cracks due to a difference in thermal expansion between an end portion and the central part of each cell at the time of application of the thermal impact can be suppressed more appropriately. For example, it is possible to more appropriately suppress the occurrence of cracks that are attributed to the thermal impact directed from the central part of the cell to the portion around the midpoint of the side (such as the first side 61) constituting the outer peripheral shape in plan view. Note that the third side 73 of the second cell 7 does not always have to be curved.

As with the battery 1000 according to the first embodiment, the battery 1100 may include the insulating member 4 that covers at least part of the side surface of the first cell 6. As illustrated in FIG. 2, the insulating member 4 may continuously cover the side surface of the battery element 5 together with stepped portions 61a and 73a formed by the different outer peripheral shapes between the first cell 6 and the second cell 7. In this case, by coating the insulating material on the side surface of the battery element 5 and fixing the insulating material thereto, the stepped portions 61a and 73a are filled with the insulating member 4. Accordingly, the insulating member 4 can tightly fix the first cell 6 to the second cell 7, thereby reinforcing the framework structure of the battery element 5. Thus, it is possible to realize the battery 1100 having more strength and higher reliability.

### Third Embodiment

A battery according to a third embodiment will be described below. Note that the matters that have been explained in the above-described embodiments may be omitted as appropriate.

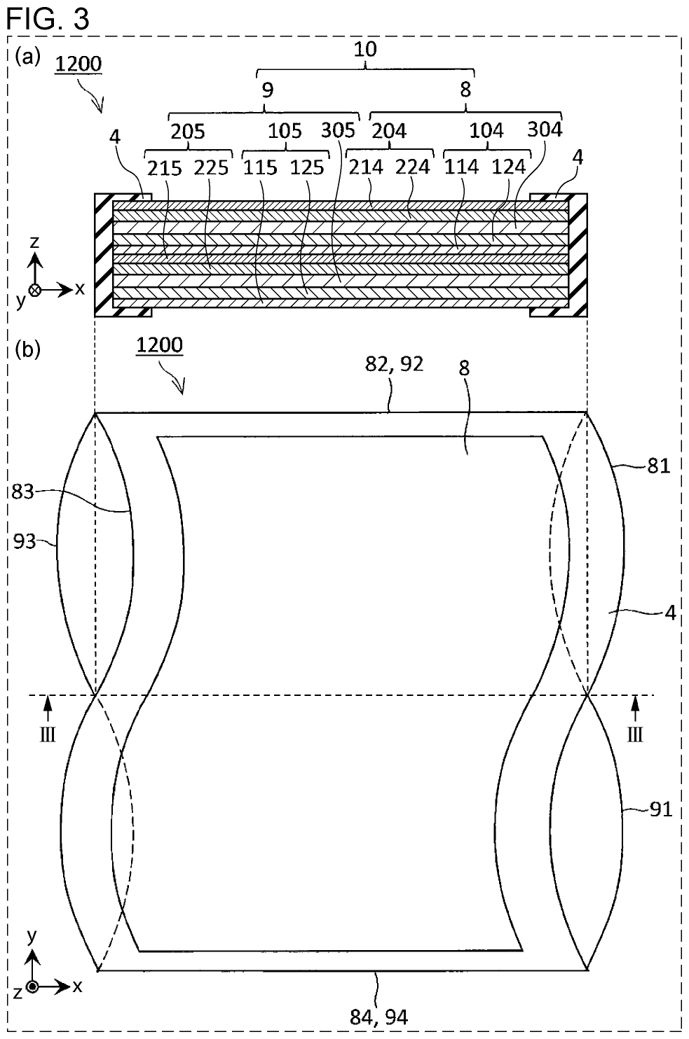

FIG. 3 illustrates a sectional view and a plan view depicting a schematic configuration of a battery 1200 according to the third embodiment. FIG. 3(a) is the sectional view illustrating the schematic configuration of the battery 1200 according to the third embodiment. FIG. 3(b) is the plan view illustrating the schematic configuration of the battery 1200 viewed from a positive side in the z-axis direction. FIG. 3(a) illustrates the section taken at a location indicated by line III-III in FIG. 3(b).

The battery 1200 includes a first cell 8 and a second cell 9. The first cell 8 and the second cell 9 are laminated on each other. In the battery 1200, a laminated body of the first cell 8 and the second cell 9 constitutes a battery element 10.

The first cell 8 is a single cell that includes a first positive electrode layer 104, a first negative electrode layer 204, and a first solid electrolyte layer 304 disposed between the first positive electrode layer 104 and the first negative electrode layer 204. The first positive electrode layer 104 may include a first positive electrode current collector 114 and a first positive electrode active material layer 124. The first negative electrode layer 204 may include a first negative electrode current collector 214 and a first negative electrode active material layer 224. The first cell 8 may include the first positive electrode current collector 114, the first positive electrode active material layer 124, the first solid electrolyte layer 304, the first negative electrode active material layer 224, and the first negative electrode current collector 214 in this order.

The second cell 9 may be a single cell including a second positive electrode layer 105, a second negative electrode layer 205, and a second solid electrolyte layer 305 disposed between the second positive electrode layer 105 and the second negative electrode layer 205 as with the first cell 8. The second positive electrode layer 105 may include a second positive electrode current collector 115 and a second positive electrode active material layer 125. The second negative electrode layer 205 may include a second negative electrode current collector 215 and a second negative electrode active material layer 225.

The first cell 8 is electrically connected to the second cell 9. For example, the first cell 8 is connected to the second cell 9 in series while a conductive material is interposed in between. For instance, the first positive electrode layer 104 of the first cell 8 is joined to the second negative electrode layer 205 of the second cell 9 while the conductive material is interposed in between. The first positive electrode current collector 114 and the second negative electrode current collector 215 joined to each other constitute a so-called bipolar electrode in which one end functions as a positive electrode while another end functions as a negative electrode. Although FIG. 3 illustrates the configuration in which the first positive electrode layer 104 of the first cell 8 is joined to the second negative electrode layer 205 of the second cell 9, the first cell 8 and the second cell 9 may be laminated in reverse order. Specifically, the battery 1200 may have a configuration to join the first negative electrode layer 204 of the first cell 8 to the second positive electrode layer 105 of the second cell 9.

The first cell 8 has an outer peripheral shape that includes a first side 81 having curved portions in plan view. The outer peripheral shape of the first cell 8 in plan view may further include a third side 83 having curved portions. In the battery 1200 according to the third embodiment, the first side 81 is curved in an undulated shape. That is to say, the first side 81 includes two curved portions, namely, a portion curved outward of the cell and a portion curbed inward thereof. The third side 83 located at a position facing the first side 81 may also be curved in an undulated shape as with the first side 81. The first cell 8 may have a schematic quadrangular shape in plan view as illustrated in FIG. 3(b). That is to say, the first cell 8 has an outer peripheral shape defined by the first side 81, a second side 82, the third side 83, and a fourth side 84 in plan view. Here, the first side 81 may face the third side 83 while the second side 82 may face the fourth side 84. The following description will discuss an example in which the schematic shape of the first cell 8 in plan view is the quadrangle defined by the first to fourth sides. However, the shape of the first cell 8 is not limited to this shape. The outer peripheral shape of the first cell 8 in plan view only needs to include the first side 81 having the curved portions. In this context, the outer peripheral shape may be defined by less than or equal to three sides or greater than or equal to five sides, for example.

The second cell 9 may have an outer peripheral shape that includes a first side 91 and a third side 93 each having curved portions in plan view. In the battery 1200 according to the third embodiment, each of the first side 91 and the third side 93 is curved in an undulated shape. That is to say, each of the first side 91 and the third side 93 includes two curved portions, namely, a portion curved outward of the cell and a portion curbed inward thereof. As described above, in the battery 1200 according to the third embodiment, the second cell 9 may have the outer peripheral shape that includes the sides having the undulated curved portions in plan view as with the first cell 8. For example, the outer peripheral shape of the second cell 9 in plan view may be defined by the first side 91, a second side 92, the third side 93, and a fourth side 94. The first side 91 is located at a position corresponding to the first side 81 of the first cell 8. The second side 92 is located at a position corresponding to the second side 82 of the first cell 8. The third side 93 is located at a position corresponding to the third side 83 of the first cell 8. The fourth side 94 is located at a position corresponding to the fourth side 84 of the first cell 8. The third side 93 of the second cell 9 may have curved portions that are curved in the undulated shape as with the first side 81 of the first cell 8. Note that the outer peripheral shape of the second cell 9 in plan view is not limited to the quadrangle defined by the first to fourth sides, either. The second cell 9 may be formed from less than or equal to three sides or greater than or equal to five sides, for example.

The first cell 8 and the second cell 9 are laminated in such a way as to invert the curved shapes of the sides, that is to say, such that the portions curved outward of the cells correspond to the portions curbed inward of the cells. In other words, the side of the second cell 9 corresponding to the first side 81 of the first cell 8 (namely, the first side 91) may have the curved portions that are curved in opposite directions to the curved portions of the first side 81.

The first positive electrode current collector 114, the first positive electrode active material layer 124, the first solid electrolyte layer 304, the first negative electrode active material layer 224, and the first negative electrode current collector 214 in the first cell 8 have configurations corresponding to the first positive electrode current collector 110, the first positive electrode active material layer 120, the first solid electrolyte layer 300, the first negative electrode active material layer 220, and the first negative electrode current collector 210 in the first cell 2 described in the first embodiment, respectively. Meanwhile, the second positive electrode current collector 115, the second positive electrode active material layer 125, the second solid electrolyte layer 305, the second negative electrode active material layer 225, and the second negative electrode current collector 215 in the second cell 9 have configurations corresponding to the second positive electrode current collector 111, the second positive electrode active material layer 121, the second solid electrolyte layer 301, the second negative electrode active material layer 221, and the second negative electrode current collector 211 in the second cell 3 described in the first embodiment, respectively.

The battery 1200 may further include the insulating member 4 that covers at least part of a side surface of the first cell 8 as with the battery 1000 according to the first embodiment. The insulating member 4 may cover the entire side surface of the first cell 8. The insulating member 4 may further cover at least part of a side surface of the second cell 9 or cover the entire side surface of the second cell 9. In other words, the insulating member 4 may cover at least part of the side surface of the battery element 10.

As described above, the battery 1200 is different from the battery 1000 according to the first embodiment in that the outer peripheral shapes of the first cell 8 and the second cell 9 in plan view are formed such that the first side 81 as well as the third side 83 of the first cell 8 and the first side 91 as well as the third side 93 of the second cell 9 are curved in the undulated shapes. However, the remaining configurations of the battery 1200 are substantially the same as those of the battery 1000.

Since the battery 1200 includes the first cell 8 and the second cell 9 that have different shapes from each other in plan view as described above, steps (irregularities) are formed on the side surface of the battery 1200 as with the battery 1000 of the first embodiment. Thus, the external stress to be applied to the laminated body of the first cell 8 and the second cell 9 is easily absorbed or dispersed as with the battery 1000 of the first embodiment. As a consequence, it is possible to suppress interlayer delamination and cracks in the first cell 8 and the second cell 9, and thus to obtain high reliability of the battery 1200.

In the battery 1200, each of the first sides 81 and 91 as well as the third sides 83 and 93 of the first cell 8 and the second cell 9 is smoothly curved in an elliptic arc shape or an arc shape in plan view as illustrated in FIG. 3. According to the above-described configuration, the battery 1200 can achieve the effects of both the battery 1000 according to the first embodiment and the battery 1100 according to the second embodiment.

In the battery 1200, the first side 81 and the third side 83 of the first cell 8 and the first side 91 and the third side 93 of the second cell 9 are deformed into the undulated shape. However, the present disclosure is not limited to this configuration. For instance, any of the other sides may have a similar shape. Alternatively, one of the laminated first cell 8 and the second cell 9 (only the first cell, for example) may include the sides curved in the undulated shape.

### Fourth Embodiment

A battery according to a fourth embodiment will be described below. Note that the matters that have been explained in the above-described embodiments may be omitted as appropriate.

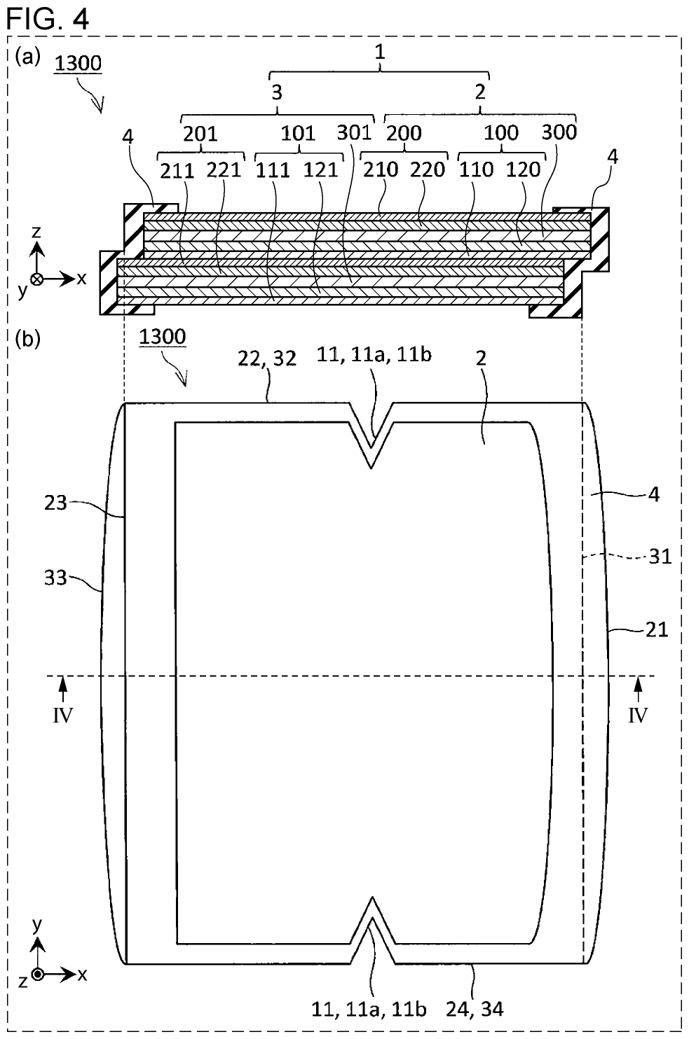

FIG. 4 illustrates a schematic configuration of a battery 1300 according to the fourth embodiment. FIG. 4(a) is a sectional view illustrating the schematic configuration of the battery 1300 according to the fourth embodiment. FIG. 4(b) is the plan view illustrating the schematic configuration of the battery 1300 viewed from a positive side in the z-axis direction. FIG. 4(a) illustrates the section taken at a location indicated by line Iv-Iv in FIG. 4(b).

The battery 1300 includes the battery element 1 in the battery 1000 of the first embodiment. However, the battery element 1 provided to the battery 1300 further includes grooves 11 on the side surfaces. These grooves 11 are formed from first grooves 11a provided on the second side 22 and the fourth side 24 of the first cell 2, and second grooves 11b provided on the second side 32 and the fourth side 34 of the second cell 3. In the battery 1300 illustrated in FIG. 4, each of the first grooves 11a and the second grooves 11b has a triangular shape in plan view. Accordingly, the grooves 11 have the triangular shape in plan view.

Each first groove 11a and the corresponding second groove 11b are provided at positions coinciding with each other in plan view. Accordingly, the first grooves 11a provided to the first cell 2 and the second grooves 11b provided to the second cell 3 can be used as position references when laminating the first cell 2 and the second cell 3. When laminating the first cell 2 and the second cell 3, for example, it is possible to ensure the position references of the two cells by pinching the sides provided with the first grooves 11a and the second grooves 11b with metal jigs each having a similar V-shape. This makes it possible to laminate the first cell 2 and the second cell 3 vertically in series, and to manufacture a high-precision multilayered cells by using the grooves 11, for instance. By adopting the above-mentioned lamination method, it is possible to laminate the first cell 2 and the second cell 3 each having a schematic external shape defined by a long side equal to 120 mm, a short side equal to 90 mm, and a thickness equal to 200 μm at positional accuracy in a range from about 0 to 50 μm, for example.

In the battery 1300, the first grooves 11a and the second grooves 11b may be covered with the insulating member 4. Specifically, the first grooves 11a and the second grooves 11b may be covered with the insulating material. Thus, the insulating member 4 can suppress delamination, cracks, and short circuits in the battery 1300 as discussed above. Moreover, when the battery 1300 is vacuum sealed in a laminated bag, the laminated bag sticks and gets fixed to the grooves 11 by the action of the atmospheric pressure, thereby pressurizing and reinforcing an outer peripheral portion that is prone to delamination. Due to the above-mentioned effects, fixation in the cells and between the laminated cells is further strengthened so that the battery at high reliability can be realized.

The shape of the grooves 11 is not limited to a particular shape. Examples of the shape include a triangle, a quadrangle, a rectangle, and an oblong.

The shape of the grooves 11 may be a triangle or a quadrangle. This configuration makes it possible to laminate the first cell 2 and the second cell 3 at high accuracy while using the grooves as the positional references. As a consequence, the steps (projections and recesses) on the side surfaces of the battery element 1 can be formed at high accuracy.

The grooves 11 may be formed on two or more sides. For example, three or more grooves 11 may be provided to the battery element 1. The grooves 11 may have different shapes and sizes from one another.

The grooves 11 may also be filled with the insulating member 4.

### Fifth Embodiment

A battery according to a fifth embodiment will be described below. Note that the matters that have been explained in the above-described embodiments may be omitted as appropriate.

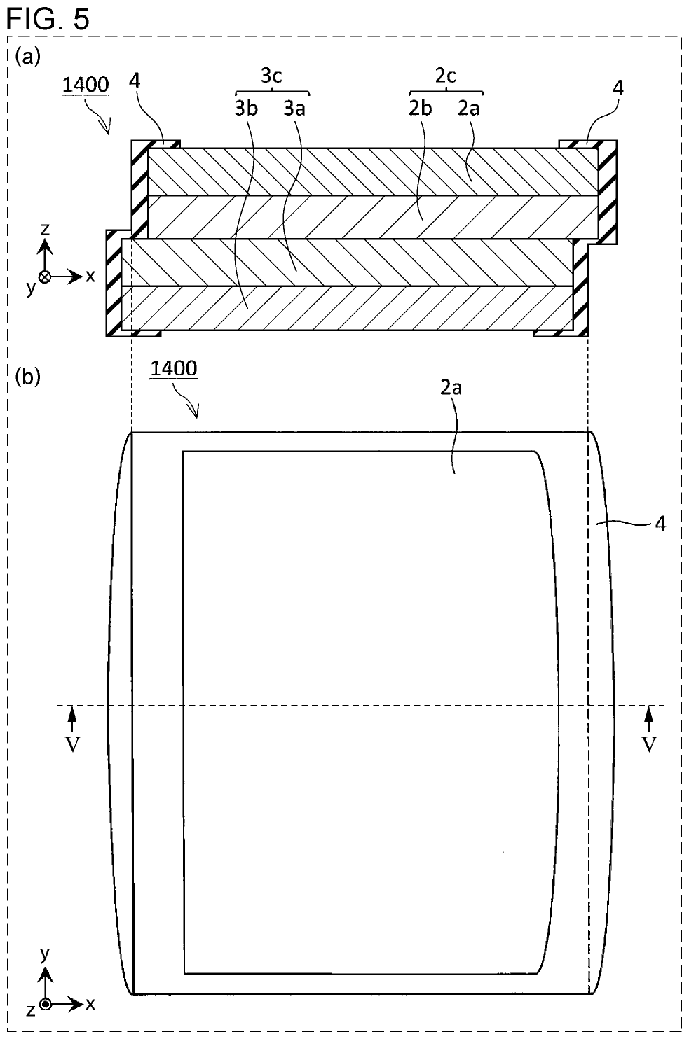

FIG. 5 illustrates a sectional view and a plan view depicting a schematic configuration of a battery 1400 according to the fifth embodiment. FIG. 5(a) is the sectional view illustrating the schematic configuration of the battery 1400 according to the fifth embodiment. FIG. 5(b) is the plan view illustrating the schematic configuration of the battery 1400 viewed from a positive side in the z-axis direction. FIG. 5(a) illustrates the section taken at a location indicated by line V-V in FIG. 5(b).

The battery 1400 is different from the battery 1000 in that the battery 1400 includes a laminated cell 2c including two layers of a single cell 2a and a single cell 2b connected in series instead of including the first cell 2 being the single cell, and that the battery 1400 includes a laminated cell 3c including two layers of a single cell 3a and a single cell 3b connected in series instead of the second cell 3 being the single cell. Here, the single cell 2a and the single cell 2b have the same configuration as that of the first cell 2 in the battery 1000 according to the first embodiment. Meanwhile, the single cell 3a and the single cell 3b have the same configuration as that of the second cell 3 in the battery 1000 according to the first embodiment. Except for the use of the laminated cells as the first cell and the second cell, the battery 1400 has the same configuration as that of the battery 1000 according to the first embodiment.

As described above, it is possible to realize high reliability of the thin-layered and the large-sized battery even by using the laminated cell 2c as the first cell and using the laminated cell 3c as the second cell. Thus, the battery 1400 with high energy density, a large capacity, and high reliability is obtained.

### Sixth Embodiment

A battery according to a sixth embodiment will be described below. Note that the matters that have been explained in the above-described embodiments may be omitted as appropriate.

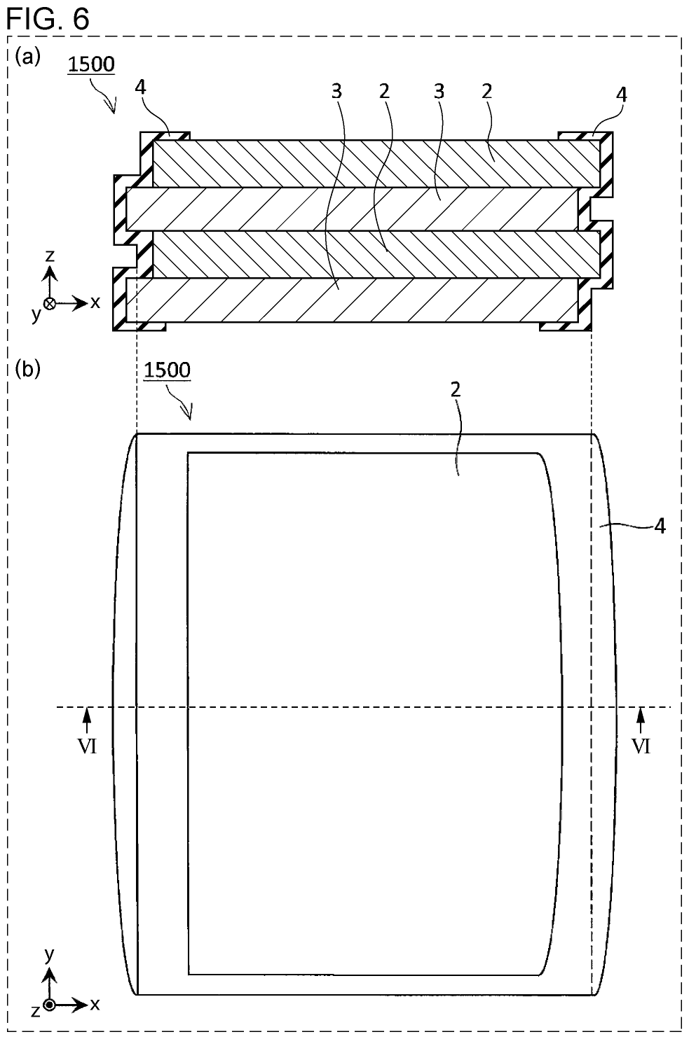

FIG. 6 illustrates a sectional view and a plan view depicting a schematic configuration of a battery 1500 according to the sixth embodiment. FIG. 6(a) is the sectional view illustrating the schematic configuration of the battery 1500 according to the sixth embodiment. FIG. 6(b) is the plan view illustrating the schematic configuration of the battery 1500 viewed from a positive side in the z-axis direction. FIG. 6(a) illustrates the section taken at a location indicated by line VI-VI in FIG. 6(b).

The battery 1500 has a configuration in which four cells are connected in series. For example, the battery 1500 has a configuration to laminate two batteries 1000 according to the first embodiment, or more specifically, a configuration to laminate the first cell 2, the second cell 3, the first cell 2, and the third cell 3 of the battery 1000 according to the first embodiment in this order.

According to the above-described configuration, it is possible to realize high reliability of the thin-layered and large-sized cells. Thus, the battery 1500 with high energy density, a large capacity, and high reliability is obtained.

### Method of Manufacturing Battery

Now, a method of manufacturing a battery according to the present disclosure will be described below. Here, a method of manufacturing the battery 1000 according to the first embodiment will be described as an example.

A description will be given of a method of manufacturing the first cell 2 and the second cell 3.

First, each paste used for printing and forming the positive electrode active material layer and the negative electrode active material layer is produced. Glass powder of Li₂S-P₂S₅-based sulfide having average grain sizes of about 10 μm and containing triclinic crystals as a chief component is prepared, for example, as a solid electrolyte raw material used in each of compounds for the positive electrode active material layer and the negative electrode active material layer. This glass powder has high ion conductivity that is greater than or equal to 2×10⁻³ S/cm and less than or equal to 5×10⁻³ S/cm, for example. As for the positive electrode active material, LiNiCoAl composite oxide (such as LiNi_{0.8}Co_{0.15}Al_{0.05}O₂) powder with average grain sizes of about 5 μm and having a layered structure is used, for example. The paste for the positive electrode active material layer is produced by dispersing a compound containing the above-mentioned positive electrode active material and the above-mentioned glass powder into an organic solvent and the like. As for the negative electrode active material, natural graphite powder with average grain sizes of about 10 μm is used, for example. The paste for the negative electrode active material layer is produced by dispersing a compound containing the above-mentioned negative electrode active material and the above-mentioned glass powder into the organic solvent and the like.

Next, a copper foil having a thickness of about 15 μm is prepared as the positive electrode current collector and the negative electrode current collector, for example. Each of the paste for the positive electrode active material layer and the paste for the negative electrode active material layer is printed on one surface of the corresponding copper foil into a predetermined shape and at a thickness greater than or equal to about 50 μm and less than or equal to about 100 μm in accordance with a screen-printing method. Each of the paste for the positive electrode active material layer and the paste for the negative electrode active material layer is dried at a temperature in a range higher than or equal to 80° C. and lower than or equal to 130° C. In this way, the positive electrode active material layer is formed on the positive electrode current collector, and the negative electrode active material layer is formed on the negative electrode current collector. Thus, the positive electrode layer and the negative electrode layer are obtained. Each of the positive electrode layer and the negative electrode layer has the thickness greater than or equal to 30 μm and less than or equal to 60 μm.

Then, paste for the solid electrolyte layer is produced by dispersing the above-mentioned glass powder into the organic solvent and the like. The above-mentioned paste for the solid electrolyte layer is printed in a thickness of about 100 μm, for example, on the positive electrode layer and the negative electrode layer by using a metal mask. Thereafter, the positive electrode layer and the negative electrode layer on which the paste for the solid electrolyte layer is printed are dried at a temperature higher than or equal to 80° C. and lower than or equal to 130° C.

Subsequently, the positive electrode layer and the negative electrode layer are laminated such that the solid electrolyte printed on the positive electrode layer and the solid electrolyte printed on the negative electrode layer face and come into contact with each other. The laminated body thus obtained is subjected to pressurization using a pressing die. To be more precise, an elastic body sheet having a thickness of 70 μm and an elastic modules of about 5×10⁶ Pa is inserted between the laminated body and the pressing die plate, that is, placed on an upper surface of the current collector of the laminated body, for example. Using this structure, a pressure is applied to the laminated body through the elastic body sheet. Thereafter, the laminated body is pressed for 90 seconds at the pressure of 300 MPa while the pressing die is heated at 50° C. Thus, the positive electrode layer, the solid electrolyte layers, and the negative electrode layer are joined to and integrated with one another. The laminated body integrated as described above is stamped into a predetermined shape while the pressure is applied thereto. Specifically, the first cell having such a shape that at least the first side has the curved portion, and the second cell are obtained by cutting the laminated body. Here, when the cutting is carried out under the state of applying the pressure, the cells may be deformed when the pressure is released after the cutting. Accordingly, the laminated body is desirably cut out in accordance with the targeted shapes of the first cell and the second cell while the deformation of the cells after the cutting is considered as well.

The first cell 2 and the second cell 3 are obtained after carrying out the above-described procedures.

When laminating the first cell 2 and the second cell 3, thermosetting conductive paste containing silver particles is screen-printed in a thickness of about 20 to 30 μm on the surface of the current collector of the first cell 2 to be joined, and the second cell 3 is arranged at a predetermined position and brought into pressure bonding. Thereafter, the cells are left to stand while a pressure of about 1 kg/cm² is applied thereto, for example. Then, the cells are subjected to a thermal curing process for 60 minutes at a temperature higher than or equal to about 100° C. and lower than or equal to 300° C., and the cells are gradually cooled down to room temperature. In this way, the battery element 1 including the first cell 2 and the second cell 3 each being the single battery are obtained.

Next, a description will be given of a method of forming the insulating member 4. The insulating member 4 can be formed by using an edge coating method, which is one of edge electrode forming methods carried out for forming chip components as typified by multilayer ceramic capacitors (MLCC), for example. A resin material is coated into a thin film and disposed on a prescribed flat plate, for instance. The flat plate is a flat and smooth metal plate, for example. The resin material is a material serving as a source of the insulating member 4, which is epoxy resin in a liquid form, for instance. To be more precise, the resin material adheres to the side surface of the battery element 1 by thrusting the side surface of the battery element 1 against the resin material in the form of the thin film coated on the flat plate. The resin material is attached to the entire side surface by rotating the battery element 1. The insulating member 4 is formed by curing the attached resin material.

Note that the coated state of the resin material also varies with viscosity of the resin material or wettability, the surface condition, and the like of the battery element 1. Accordingly, the viscosity of the used resin material as well as the conditions of the side surface and the principal surface of the battery element 1 may are desirably adjusted. For example, provision of appropriate roughness on the side surface will disperse surface energy and improve wettability, thereby bringing about fine controllability of coating geometry of the resin material.

For example, a surface having fine asperities with surface roughness Rz of about 0.5 μm can be formed only by polishing a chamfered surface with 10000 grit sandpaper. Meanwhile, an end surface of the current collector is also polished in this instance, whereby a metal surface without absorptive ability is exposed. For this reason, the end surface is apt to repel the resin material. However, the resin material is repelled less by forming a bonding surface with fine asperities in advance, so that the resin material can be easily coated thereon. Accordingly, it is possible to coat the resin material accurately on a desired coating region. Moreover, an increasing effect of the bonding area attributed to the surface roughness further strengthens the anchoring effect of the insulating member 4. Hence, it is also possible to achieve an effect of improving junction strength between the insulating member 4 and the battery element 1.

In the meantime, the insulating member 4 can also be formed by coating and thermally curing epoxy resin in a powder form instead of the epoxy resin in the liquid form.

The battery 1000 is obtained after carrying out the above-described procedures.

Note that the method and the order of forming the battery are not limited to the above-described example.

For example, the insulating resin material may be coated on the side surface of the battery element 1 in accordance with screen printing. The insulating member 4 can be formed by curing the resin material coated in accordance with the screen printing.

In the case of the battery element including two or more cells, for example, the insulating material may be coated after laminating the cells. Alternatively, the insulating material may be coated on each of the cells, and the cells with the coated insulating material may be laminated thereafter.

The above-described manufacturing method shows the example of coating the paste for the positive electrode active material layer, the paste for the negative electrode active material layer, the paste for the solid electrolyte layer, and the conductive paste by means of screen printing. However, the present disclosure is not limited to this configuration. Examples of other printing methods include a doctor blade method, a calender method, a spin-coating method, a dip-coating method, an inkjet method, an offset method, a die-coating method, and a spray method.

The above-described manufacturing method shows the example of using the thermosetting conductive paste containing silver metal particles as the conductive paste. However, the present disclosure is not limited to this configuration. Meanwhile, the resin used in the thermosetting conductive paste only needs to function as the binder, and an appropriate resin is selected in consideration of a printing performance, a coating performance, and the like depending on manufacturing processes to be employed. The resin used in the thermosetting conductive paste contains a thermosetting resin, for instance. Examples of the thermosetting resin include (i) amino resins including urea resin, melamine resin, guanamine resin, and the like, (ii) epoxy resins of bisphenol A type, bisphenol F type, phenol novolac type, alicyclic type, and the like, (iii) oxetane resin, (iv) phenol resins of resol type, novolac type, and the like, and (v) silicone-modified organic resins including silicone-epoxy resin, silicone polyester resin, and the like. The relevant resin may adopt only one of these materials or a combination of two or more of these materials.

The battery and the manufacturing method thereof according to the present disclosure have been described above based on certain embodiments. It is to be noted, however, that the present disclosure is not limited to these embodiments. Various modifications conceived and applied to the respective embodiments by a person skilled in the art, and other modes constructed by combinations of certain constituents selected from different embodiments will also be encompassed by the scope of the present disclosure.

A battery according to the present disclosure is applicable to a secondary battery such as an all-solid-state battery, which is used in various electronic devices and automobiles, for example.

What is claimed is:

1. A battery comprising:
a first cell; and
a second cell disposed on the first cell, wherein
the first cell includes:
a first positive electrode layer;
a first negative electrode layer; and
a first solid electrolyte layer disposed between the first positive electrode layer and the first negative electrode layer,
the first cell has an outer peripheral shape that includes a first side having a curved portion in plan view, and
the outer peripheral shape of the first cell includes a portion on the first side that does not coincide with an outer peripheral shape of the second cell in plan view.

2. The battery according to claim 1, wherein
the second cell includes:
a second positive electrode layer;
a second negative electrode layer; and
a second solid electrolyte layer disposed between the second positive electrode layer and the second negative electrode layer.

3. The battery according to claim 1, wherein a side of the second cell corresponding to the first side of the first cell is formed of a straight line in plan view.

4. The battery according to claim 1, wherein a side of the second cell corresponding to the first side of the first cell has a curved portion that is curved in an opposite direction to the curved portion of the first side in plan view.

5. The battery according to claim 1, wherein
when a point on the first side where a minimum distance from a straight line connecting two ends of the first side reaches a maximum is defined as a maximum projecting point, the minimum distance between the straight line and the maximum projecting point is greater than a thickness of the first cell.

6. The battery according to claim 1, wherein the first side is curved outward of the first cell.

7. The battery according to claim 1, wherein the first side is curved inward of the first cell.

8. The battery according to claim 1, wherein the first side is curved in an undulated shape.

9. The battery according to claim 1, further comprising:
an insulating member that covers at least part of a side surface of the first cell including the first side.

10. The battery according to claim 1, wherein
a side surface that defines the outer peripheral shape of the first cell includes a first groove,
a side surface that defines the outer peripheral shape of the second cell includes a second groove, and
the first groove and the second groove are provided at positions coinciding with each other in plan view.

11. The battery according to claim 10, wherein each of the first groove and the second groove has a triangular shape in plan view.

12. The battery according to claim 10, wherein each of the first groove and the second groove has a quadrangular shape in plan view.

13. The battery according to claim 10, wherein each of the first groove and the second groove is covered with an insulating material.

14. The battery according to claim 1, wherein
the outer peripheral shape of the first cell is defined by the first side, a second side, a third side, and a fourth side,
the first side faces the third side, and
the second side faces the fourth side.
